(19) United States
(12) Patent Application Publication
(10) Pub. No.: US 2024/0403394 A1
(43) Pub. Date: Dec. 5, 2024

(54) SECURE PROCESSOR FOR DETECTING AND PREVENTING EXPLOITS OF SOFTWARE VULNERABILITY

(71) Applicant: The Research Foundation for The State University of New York, Binghamton, NY (US)

(72) Inventor: Kanad Ghose, Vestal, NY (US)

(21) Appl. No.: 18/801,580

(22) Filed: Aug. 12, 2024

Related U.S. Application Data
(63) Continuation of application No. 18/238,079, filed on Aug. 25, 2023, now Pat. No. 12,061,677.
Application No. 18/238,079 is a continuation of application No. 16/684,233, filed on Nov. 14, 2019, now Pat. No. 11,741,196.
(60) Provisional application No. 62/767,908, filed on Nov. 15, 2018.

(51) Int. Cl. G06F 21/12; G06F 9/32; G06F 9/38; G06F 12/10; G06F 21/62

(52) U.S. Cl. CPC G06F 21/123; G06F 9/322; G06F 9/3842; G06F 12/10; G06F 21/62; G06F 2212/1052; G06F 2212/452

(57) ABSTRACT

A secure processor, comprising a logic execution unit configured to process data based on instructions; a communication interface unit, configured to transfer of the instructions and the data, and metadata tags accompanying respective instructions and data; a metadata processing unit, configured to enforce specific restrictions with respect to at least execution of instructions, access to resources, and manipulation of data, selectively dependent on the received metadata tags; and a control transfer processing unit, configured to validate a branch instruction execution and an entry point instruction of each control transfer, selectively dependent on the respective metadata tags.

### CROSS REFERENCE TO RELATED APPLICATIONS

The present application is a Continuation of U.S. patent application Ser. No. 18/238,079, filed Aug. 23, 2023, now U.S. Pat. No. 12,061,677, issued Aug. 13, 2024, which is a Continuation of U.S. patent application Ser. No. 16/684,233 filed Nov. 14, 2019, now U.S. Pat. No. 11,741,196, issued Aug. 29, 2023, which is a Non-provisional of, and claims benefit of priority under, U.S. Provisional Patent Application No. 62/767,908, filed Nov. 15, 2019, the entirety of which is expressly incorporated herein by reference.

### FIELD OF THE INVENTION

The present invention relates to the field of secure processors, and more particularly to processors which tag code and data with metadata which controls or restricts access and/or execution privileges.

### BACKGROUND OF THE INVENTION

Since 2005, Mitre Corporation has developed a list of common types of software vulnerabilities or weaknesses that lead to security violations in a computing system. See, cwc.mitre.org/index.html, and cve.mitre.org/data/downloads/allitems.html. See also, the National Vulnerability Database (NIST), nvd.nist.gov/.

Security-tagged architectures have been around for over five decades in research projects as well as commercially available processors like the Burrough's families of stack machines [37], the Intel iAPX 432 [30], the IBM System 38 [26] and others [19, 33, 35]. MINOS [12] adds a single bit tag to a data word, in the worst case, to protect the integrity of control flow data. In [42], instruction and data tags are used to track data from suspect inputs to prevent their malicious use as instructions of targets of jumps. Efforts such as LIFT [39], RAKSHA [13] and RIFLE [45] have used tagging to primarily track information flow. More elaborate tagging and metadata tags have been used in a number of other projects [2, 15] to implement a richer variety of security functions, designate proper usage of sensitive data structures and provide programmable security policies [15, 44]. The T-core processor uses two hardware-controlled tag bits per byte in memory to track taints and control flow integrity marks [3].

In all of this existing, the focus has been to use tags largely to enforce data usage and, barring the exception noted below, tags have not been used pervasively to enforce context-specific usage of existing instructions. Existing work have also used function tagging [2] to enforce security policies.

The concept of protection domains as security compartments have been around for a while [7, 10, 11, 17, 22, 33, 34, 48, 50].

The use of secure pointers and bounds register together implement functionality very similar to those realized in some designs with capability-based addressing [33,37]. However, capabilities in their purest form have no concept of a traditional address for the associated object. Instead, a unique object ID is used to refer to an object, which is then translated to a memory address.

The Security Tagged Architecture Co-Design (STACD) initiative discussed in [2] focused on eliminating inherent software vulnerabilities by redesigning the underlying hardware and the operating system to enforce software security policies and semantics. The proposed approach uses a metadata processing unit known as the Tagged Management Unit [or Tag management Unit] (TMU) that operates concurrently with the Central Processing Unit (CPU) to process the metadata. The introduction of tag-capable hardware requires software that uses tagged information.

Processors, such as Intel's ×86 architecture, provide 2-bit tagging, to provide what is known as the ring architecture, which separates information into three domains; 0—The Kernel Domain, 1 & 2—Middle Domains (largely ignored), 3—User Domain. All kernel code and data must operate in the Kernel Domain (ring 0) while user code and data must remain in User Domain (ring 3). This technique increases the security of the system by providing isolation and separation of information, adhering to the security policy. However, Intel did not take into consideration the systems software. In order to use certain system functions, the user must perform a costly context switch into the Kernel Domain, which forced widespread violations of security policy by the hardware, allowing users to inject a portion of their code into the Kernel Domain.

The ST-ZKOS implements a 32-bit tag that is paired with each 32-bit word in memory. This effectively cuts the amount of memory. There are three primary fields:
Owner Field—this field indicates the entity that owns the resource managed by the code module. All code and data on the system have been separated into code modules that perform specific functions based on the concept of least privilege. An example of a code module would be the garbage collector, or a device driver.
Code-space Field—this field indicates the code modules that are currently executing and/or the code modules that are authorized to access specific operating system resources.
Control-bits Field—this field is used to even further support least privilege by providing some typing and access control information to system resources.

Each component on the bus would be associated with a single owner at any given time. Any master component owned by one entity would not be able to read/write from/to any slave component owned by another entity. Additionally, since the provenance of all components and the intent of their designers cannot be guaranteed, permission from the controller is required for component to accessing the bus (read or write), except for access requests. The bus width was widened to permit the 32-bit tag to accompany the associated code and data.

In order to associate each component on the bus with a specific owner, the components needed a way to identify who their owner is. The owner field of the tagging scheme allows each component to identify an owner. The other fields of the tag are used by the tag management unit to indicate what rules the data/code must follow in the processor and are not relevant for the interconnect.

Software needs a means to set the tag value for each component, thus identifying the owner. To accomplish this, the plug and play information for each component is stored in a record array in the arbiter of the controller. The arbiter needs to be modified such that this array is now memory mapped so that software can address it to assign tags for each component. When a master component, after having been granted sole access to the bus, writes data to a specific address, the arbiter will interpret the address to identify which slave component should receive the data, and will also compare the tag of the master with the tag of the slave from the memory mapped array to determine if they are owned by the same entity. If they are not, then the arbiter reports an error and cancels the transaction. Most memory components are shared among various owners.

Software needs to ensure that one owner does not attempt to overwrite the memory locations of another owner. The arbiter will not perform tag checks on writes to memory, such as Direct Memory Access (DMA) writes. For DMA writes, the arbiter will assign the master's tag to all data from the master on the tag bus to memory. This approach allegedly does not sacrifice security as the new data is tagged appropriately according to the owner of the master. Therefore, it is important that software assign the tag appropriately. The arbiter performs tag checks on reads from memory when the requesting master is not a processor. If the requesting master is not a processor, then the tag of the data is compared to the tag of the requesting master. If the tags do not match, then the arbiter initiates an error response and terminates the transaction.

See, U.S. Pat. Nos. 3,956,615; 5,204,840; 7,171,689; 7,194,769; 7,219,239; 7,254,586; 7,346,922; 7,376,969; 7,451,488; 7,464,407; 7,607,169; 7,650,638; 7,673,345; 7,743,421; 7,752,255; 7,752,459; 7,761,917; 7,761,918; 7,788,722; 7,861,299; 7,926,113; 7,958,549; 7,962,961; 8,028,341; 8,055,732; 8,055,797; 8,056,130; 8,065,725; 8,095,984; 8,127,359; 8,141,155; 8,161,540; 8,176,001; 8,176,527; 8,201,257; 8,209,753; 8,224,930; 8,230,507; 8,234,711; 8,281,036; 8,296,848; 8,306,228; 8,316,448; 8,332,367; 8,365,278; 8,365,289; 8,381,192; 8,392,997; 8,422,379; 8,438,532; 8,438,643; 8,458,798; 8,468,606; 8,474,004; 8,484,741; 8,516,594; 8,522,348; 8,533,843; 8,544,098; 8,566,928; 8,572,550; 8,572,750; 8,595,845; 8,601,104; 8,601,530; 8,602,089; 8,607,336; 8,611,232; 8,612,936; 8,613,083; 8,615,656; 8,627,402; 8,631,248; 8,631,489; 8,640,240; 8,644,516; 8,650,637; 8,730,946; 8,762,188; 8,776,180; 8,789,192; 8,789,193; 8,813,235; 8,819,420; 8,826,438; 8,844,043; 8,844,045; 8,850,588; 8,856,936; 8,869,110; 8,874,685; 8,893,283; 8,903,705; 8,918,884; 8,918,887; 8,925,082; 8,949,169; 8,966,619; 8,966,639; 8,984,579; 8,984,643; 8,990,948; 9,003,537; 9,027,125; 9,032,533; 9,043,753; 9,043,920; 9,047,293; 9,069,930; 9,092,616; 9,094,448; 9,118,706; 9,128,801; 9,141,378; 9,141,805; 9,158,871; 9,160,761; 9,165,133; 9,166,994; 9,178,911; 9,224,117; 9,256,746; 9,268,945; 9,270,695; 9,276,951; 9,292,695; 9,298,923; 9,305,165; 9,306,969; 9,306,975; 9,317,692; 9,317,708; 9,319,425; 9,323,921; 9,325,729; 9,369,482; 9,372,995; 9,389,933; 9,392,007; 9,407,645; 9,411,965; 9,413,538; 9,425,965; 9,456,004; 9,467,464; 9,467,465; 9,473,529; 9,479,535; 9,495,183; 9,503,467; 9,516,058; 9,537,876; 9,537,884; 9,544,326; 9,588,803; 9,602,529; 9,614,864; 9,619,655; 9,628,501; 9,633,213; 9,635,033; 9,648,036; 9,665,721; 9,680,699; 9,680,861; 9,686,291; 9,690,583; 9,692,778; 9,692,779; 9,716,721; 9,722,803; 9,726,460; 9,727,736; 9,729,568; 9,762,617; 9,779,191; 9,792,438; 9,817,978; 9,825,981; 9,825,982; 9,846,780; 9,860,265; 9,866,426; 9,871,815; 9,881,271; 9,886,303; 9,886,581; 9,886,582; 9,887,886; 9,894,088; 9,898,739; 9,900,339; 9,912,683; 9,923,916; 9,923,917; 9,928,369; 9,930,065; 20030167406; 20030182572; 20040003278; 20040143730; 20040172557; 20040218762; 20050005169; 20050010821; 20050138413; 20050187963; 20050229255; 20060069912; 20060225135; 20060259726; 20060259828; 20060265324; 20060265751; 20070061874; 20070061885; 20070067846; 20070067847; 20070067848; 20070162890; 20070169199; 20070177615; 20070192866; 20070192867; 20080005784; 20080060077; 20080068381; 20080071793; 20080071826; 20080071871; 20080071888; 20080071889; 20080071891; 20080071896; 20080071898; 20080072032; 20080072241; 20080072277; 20080072278; 20080089521; 20080092237; 20080127293; 20080127349; 20080172739; 20080222724; 20080256638; 20080270104; 20080271018; 20080271019; 20080271025; 20080282339; 20080313739; 20080314570; 20090007269; 20090028135; 20090077666; 20090099885; 20090100077; 20090103524; 20090106318; 20090113550; 20090204591; 20090254993; 20090281864; 20090293100; 20100042824; 20100050266; 20100095235; 20100095381; 20100154066; 20100192228; 20100275263; 20100306851; 20110030057; 20110047369; 20110060809; 20110093954; 20110125548; 20110138469; 20110138471; 20110141877; 20110191854; 20110231936; 20120185945; 20120203590; 20120204261; 20120222123; 20120232679; 20120246103; 20120260306; 20120272205; 20120284221; 20120304299; 20120304300; 20120311534; 20120311715; 20130055394; 20130074038; 20130074188; 20130086688; 20130125204; 20130167240; 20130179685; 20130182561; 20130191808; 20130191919; 20130198846; 20130227698; 20130247206; 20130268253; 20130297375; 20130298192; 20130298230; 20130298242; 20130298243; 20130298244; 20130326469; 20140007241; 20140032505; 20140047545; 20140059683; 20140068267; 20140075414; 20140082733; 20140137257; 20140165204; 20140172495; 20140173731; 20140173737; 20140181975; 20140181976; 20140189787; 20140189873; 20140196154; 20140201843; 20140215614; 20140215629; 20140218389; 20140237545; 20140245376; 20140283083; 20140317677; 20140337971; 20140337974; 20140366145; 20140373160; 20150033340; 20150040220; 20150040228; 20150058993; 20150067323; 20150067762; 20150088733; 20150106873; 20150172307; 20150213358; 20150222655; 20150235164; 20150237062; 20150237065; 20150241139; 20150242637; 20150244734; 20150244735; 20150288712; 20150295948; 20150301515; 20150304337; 20150310217; 20160006735; 20160012236; 20160020959; 20160034682; 20160057164; 20160063248; 20160063249; 20160063250; 20160063251; 20160063252; 20160065598; 20160072835; 20160078377; 20160105455; 20160119373; 20160180080; 20160188882; 20160205122; 20160212153; 20160232358; 20160234065; 20160248794; 20160248796; 20160253590; 20160259944; 20160261640; 20160269435; 20160337484; 20160366174; 20160378994; 20170026401; 20170034023; 20170034089; 20170034200; 20170046519; 20170053115; 20170061133; 20170078322; 20170091465; 20170093910; 20170142138; 20170149786; 20170149816; 20170169217; 20170171236; 20170177367; 20170177368; 20170180411; 20170193239; 20170206381; 20170208084; 20170208085; 20170208093; 20170213002; 20170214708; 20170214710; 20170243009; 20170250998; 20170262655; 20170286690; 20170289187; 20170293563; 20170295181; 20170295197; 20170300911; 20170316213; 20170318048; 20170324763; 20170324766; 20170329975; 20170331682; 20170346847; 20170353313; 20170353482; 20180011708; 20180032733; 20180032736; 20180034840; 20180041539; 20180048668; 20180060867; 20180063171; 20180063172; 20180063177; 20180077156; 20180077188; 20180077193; 20180077195; 20180091539; 20180096609; and 20180103054, each of which is expressly incorporated herein by reference.

### SUMMARY OF THE INVENTION

The present technology provides a microprocessor having specific hardware support for detection of common types of software vulnerabilities or weaknesses that lead to security violations in a computing system.

This technology may be implemented as a hardware improvement that can be incorporated into an existing processor type, called a “Secure Processor” (SP) to detect exploitations of software vulnerabilities in the software, either accidentally or maliciously by compromised programs. The mechanisms employed are largely portable across different instruction sets, and are therefore not limited to any particular type of microprocessor architecture.

The security mechanism adds tags to each instruction and data word, leading to a tagged processor design for the SP. The added tag bits are used to enforce specific usage of instructions and data in the SP. The tags may be uniform in size (8-bits), or variable in size. The SP associates relatively narrow word-tags with every memory word that contains data or an instruction, to detect the exploitation of a number of software vulnerabilities.

The SP improves on existing security-tagged architectures is its pervasive use of these tags, to not only enforce the data type compliance rules of the application, but to also enforce context-specific legal uses of both data and instructions associated with control transfer, secured/bounded pointers, potentially-tainted data from an input device, and in other critical scenarios.

The SP may include additional secure features, such as word-sized, in-line metadata tags that specify access control information, which complement the word tags, which help form a basis of protection domains. Protection domains are hardware-implemented security compartments that encapsulate externally-callable and private functions, private data and can be set up to a security compartment that encompasses a single address space or set up multiple protection domains within a single address space. This permits a single application or a system component (like the OS) to be compartmentalized. The callable functions within a domain are invoked through word-tag enforced legal call gates, and every invocation uses existing control transfer primitives tagged appropriately for context-specific use. Such calls perform an access control check which can further enforce the principle of least privileges and/or other access control policies.

To secure a fenced, contiguous region of data, word tags also ensure that accesses are possible with secured pointers, with automatic bounds checking on each access. The SP's security mechanisms also include CPU-internal per-thread key registers and memory encryption engines, which together with protection domains provide information containment and isolation. In many instances, the SP uses multiple layers of protection to provide a robust solution against the software vulnerabilities.

In SP, the enforcement of proper context-specific use of many existing instructions (that are related to control flow or to accesses performed to a secured memory region with bounds enforcement) is specifically targeted with word tags for instructions to avoid the addition of new instructions that lead to an ISA bloat.

The SP implements two types of protection domains, fully-isolated and lightweight domains relying on instruction tagging to implement secure call gates and using sealed pointers to implement cross-domain calls with access checks on entry. Word tags are also used labels to enforce context-specific usage of exiting instructions for cross-domain calls. The approach taken has some similarity with earlier work on capability extensions for a RISC pipeline [21, 46].

The SP's protection domains can be used within the applications or the systems software components, specifically within the OS, libraries and utilities and are thus more homogeneous compared to Intel's SGX [11] or ISoX [17] that provide safe execution harbor to the applications from a compromised kernel and also from ARM's Trustzone, which effectively provides a safe harbor for only the trusted components in a system.

The SP's use of low-overhead local handlers is similar to RAKSHA's [13], but the SP, for added security, implements the scope of such functions only to the individual functions identified by the compiler.

The SP's fencing mechanism for limiting accesses with bounds checking to a fenced memory region uses a capability-like secure region pointer that specifies the region's address and size and the privilege level with which the region is accessed using instructions at all privilege levels as long as they have the secured pointers. This is similar to Intel's MPX extensions [28] that rely on the use of privileged instructions.

It is therefore an object to provide a secure processor, comprising: a logic execution unit configured to process data based on instructions; a communication interface unit, configured to transfer the instructions and the data, and tags accompanying respective instructions and data; a tag processing unit, configured to enforce specific restrictions with respect to at least execution of instructions, access to resources, and manipulation of data, selectively dependent on the accompanying tags; and a control transfer processing unit, configured to validate a branch instruction execution and an entry point instruction of each control transfer, selectively dependent on the respective accompanying tags.

It is also an object to provide a secure processing method, comprising: transferring instructions and data, in conjunction with tags accompanying respective instructions and data; enforcing, by a tag processing unit, specific restrictions with respect to at least execution of instructions, access to resources, and manipulation of data by an instruction execution unit, selectively dependent on the accompanying tags; and validating a branch instruction execution and an entry point instruction of each control transfer, selectively dependent on the respective accompanying tags, with a control transfer processing unit.

The tag processing unit may be implemented in hardware.

The tag processing unit may be further configured to ensure compliance with data type rules; memory access rules; context-specific data usage rules; source-dependent data usage rules; data modification rules; source-dependent instruction execution rules; context-dependent instruction execution rules; instruction sequence modification rules; control transfer instruction rules; and/or metadata tag modification rules.

The tag processing unit may be configured to enforce a restriction on use of data as an address within a memory space; data as a return address for a subroutine call; data as a target address of an indirect branch; data as a pointer; an instruction to control flow to a legal path; an instruction to call a function; an instruction to return from a function call; an instruction to access a protected domain or module; an instruction to perform a legal operation based on the source data type; and/or an instruction to bound access to a fenced memory region.

The communication interface unit may be configured to concurrently or sequentially transfer a respective instruction or data, and a respective accompanying tag.

The logic execution unit may be a RISC or CISC processor or portion thereof, with word length 8, 16, 32, or 64 bits, for example.

The tags may be 4-bits, 8-bits, or 16-bits for example.

The tag may comprise a privilege level which restricts access by the logic execution unit under control of instructions having the privilege level to the tags. The may tag comprises a second privilege level which permits access by the logic execution unit under control of instructions having the second privilege level to the tags.

At least one tag may indicate tainted instructions or data, wherein the tag processing unit requires validation of the tainted instructions or data prior to use.

The secure processor may further comprise a cryptographic unit, configured to perform cryptographic operations on information communicated through the communication interface unit. The cryptographic unit may employ distinct cryptographic keys selectively dependent on the tags. The cryptographic unit may employ distinct cryptographic keys selectively dependent on a respective thread of instruction execution.

The secure processor may further comprise an address translation unit, configured to map logical memory spaces to physical memory pages. The address translation unit may be further configured to maintain separate memory pages of instructions, data, and tags. The address translation unit may be further configured to retrieve memory pages of tags together with associated memory pages of instructions or data for storage in a common cache. The address translation unit may be further configured to maintain a privilege restriction on memory pages of instructions and tags which restricts reading, writing, and execution, unless accessed by trusted hardware or according to instructions having associated tags which indicate higher privileges. The memory pages of tags may be subject to an integrity check by the secure processor prior to execution of instructions from the memory pages of instructions.

A set of instructions comprising a code segment may be accompanied by a metadata tag, comprising at least one of a security level or a privilege level of the code segment, wherein the tag processing unit may be further configured to compare the security level or the privilege level of the code segment with a security level or a privilege level indicated by the respective tag of a calling instruction of the code segment.

The logic execution unit may have a logic execution pipeline with a first number of stages, and the tag processing unit has a tag processing pipeline with a second number of stages, the first number and the second number being the same, and wherein instruction processing advances through the logic execution pipeline at the same rate as tags advance through the tag processing pipeline processing.

The tag processing pipeline may have a tag processing stage which relies on information provided by at least one stage of the logic execution pipeline.

The logic execution pipeline may selectively process instructions in dependence on signal generated by stages of the tag processing pipeline.

The tag processing unit may comprise a tag processing pipeline, and the logic execution units comprises a logic execution pipeline, the tag processing pipeline and logic execution pipeline having synchronized operation, wherein the tag processing pipeline relies on information received the logic execution pipeline pertaining to the instructions it processes, sent from a stage in the logic execution pipeline to a corresponding stage in the tag processing pipeline, and the tag processing pipeline having at least one stage configured to generate signals that affect the behavior of the logic execution pipeline.

The secure processor may further comprise an instruction cache having cache lines, each cache line comprising memory locations for storing instructions and memory locations for storing tags, wherein the secure processor is configured to retrieve instructions based on instruction addresses, and to retrieve tags for storing in the instruction cache based on an address of a corresponding instruction.

The communication interface unit may be configured to retrieve an instruction based on an instruction address, and to retrieve a tag corresponding to the instruction based on the instruction address.

The secure processor may further comprise a data cache having cache lines, each cache line comprising memory locations for storing data and memory locations for storing tags, wherein the secure processor is configured to retrieve data based on data addresses, and to retrieve tags for storing in the data cache based on an address of corresponding data.

The communication interface unit may be configured to retrieve data based on a data address, and to retrieve a tag corresponding to the data based on the data address.

The communication interface unit may be configured to: retrieve information from a memory according to an address, store the retrieved information in a cache, and to perform a confinement check to determine whether the address is within a predefined memory region, and selectively access a tag in dependence on whether the address is within the predefined memory region.

The predefined memory region may comprise a fenced memory region demarcating by a set of guard memory words defining a starting address of a string of memory locations containing the information to be retrieved.

The fenced memory region may contain information that does not need to be protected and tagged as unmodifiable.

Each tag may have a number of bits of information dependent on a number of bits of information in a corresponding instruction.

### BRIEF DESCRIPTION OF THE DRAWINGS

FIG. 1 depicts a protected domain and its typical contents.

FIG. 2 depicts protection domains.

FIG. 3 shows a block diagram of a RISC-V rocket pipeline with security extensions for realizing the SP in Gray.

FIG. 4 shows a flowchart of a method according to one embodiment of the invention.

### DETAILED DESCRIPTION OF THE PREFERRED EMBODIMENTS

In a particular embodiment of the Secure Processor (SP), each of the aforementioned security paradigms is employed. It is noted that these may be employed individually, or in subcombination, or with other solutions to address the same potential vulnerabilities.

In this embodiment, we assume a 32-bit memory word for the following discussions, as in the 32-bit version of RISC-V. Each of the 32-bit memory words has an associated 8-bit tag. Of course, the technology is not limited to 32-bit architectures, 8-bit tags, or RISC-V architectures, and the technology may explicitly include CISC architectures, such as ×86, IA-32, IA-64, as well as ARM64, ARMv7s. ARMv7, n Vidia GPU, ATI GPU, SPARC, MIPS, etc. Likewise, the technology may encompass 4, 6, 8, 12, 16, 32, and 64-bit architectures, and other less standard word-lengths. The tags may be 2, 4, 8, 12, 16, 24, 32, 48, or 64-bits, for example.

For data words, the tag indicates the data type and allowed access mode. For 32-bit memory words containing instructions, the 8-bit tag indicates how the instruction is to be used and if the instruction has any special significance that was intended by the programmer. The tags are interpreted during execution by tag processing units provided within the instruction decoder and/or processing units. The tag processing units (as well as optional tag storage, transfer, security, etc. hardware) distinguish the SP from the parent processor architecture. Note, however, that is may be possible in some architectures to implement the SP system without hardware modification, though microcode enhancements. However, in order to achieve minimal impact on processor throughput, and freedom from reliance on trusted software, hardware support and acceleration is preferred.

The tags can get updated as the result of executing an instruction. Preferably, programs, i.e., sequences of tagged instructions, have no ability to overwrite the tags directly—tag usage and tag updates are intrinsic to the instruction semantics. Tags on critical data and instructions can also be marked as immutable and unreadable to prevent the misuse of instruction and data. Tags are preferably only manipulable under software control by a single trusted module.

The SP separates instruction and data pages for security and to simplify addressing. Tags are stored in pages separate from the data, and code pages and the tag pages are marked as non-readable, non-writeable and non-executable. Only trusted tag manipulation logic and the SP hardware can access/update these pages. As in any normal processor, page protection bits are associated with each page (and stored within TLB entries) that indicate the permitted access modes (read, write, execute). The SP relies upon a trusted compiler, linker and loader, which take care of tag generation, tag loading and linking modules. An integrity check is performed immediately after booting to ensure that tag pages were not altered during forced disruptions in the booting phase.

Tags in SP are encoded and interpreted in context, depending on whether the page is an instruction page or data page. Tables 1 and 2 describe the possible tag values for data and instruction words. Data tags indicate the type of data in the associated word and/or, in some cases, how the data is to be legally used (e.g., as a return address or as the target of an indirect branch or as a pointer). Instruction tags are used to enforce control flow to legal paths, to enforce legal ways to call and return from functions and protected domains or modules and enforce legal data operations based on the source data type as well as bounded accesses to fenced memory regions. Note that, in effect, the instruction tags extend the ISA by designating specific context-dependent variant of some existing instructions. This, in effect, permits the extensions to be retrofitted into an existing datapath relatively easily. Additional combinations of the word tags shown in Tables 1 and 2 are also possible.

The storage overhead of tags, with 32-bit data words and 32-bit instructions (as in a RISC-V variant) is thus 25%. For the 64-bit RISC-V implementations, the storage overhead for tags is 12.5%.

### Metadata Tags

Metadata tags (MDTs) in SP are in line with the code as a 32-bit tagged entity, and such tags carry information used for access control, control flow integrity markers for indirect branches, information about local validated exception handlers that can be quickly invoked within a function. When a single MDT is not enough to convey the information needed, a sequence of metadata tags with appropriate indicators for the contents and flags to indicate the start and end of the sequence can be used. MDTs are generated by the compiler and are marked as immutable by all software, excepting the trusted software module that updates tags. MDTs can be implemented as 32-bit words tagged [EMD] that are embedded within the code. The 32-bit metadata word contains other indicators that specify its remaining contents. Embedding metadata within code makes it possible to exploit the temporal and spatial locality in accessing instructions.

The MDT containing access information within a code segment can include the security or privilege level of the code segment and can be compared against the caller's privilege level to implement class-based access control (e.g., MLS). Alternatively, or in addition, MDTs used for access control can include pointers to access control lists (whitelist and/or blacklist), permitted access mode to data private to the called segment. MDT s are also used for specifying local exception handlers, invoked essentially as a function call. Note that from the standpoint of the baseline processor, the MDTs are effectively NOPs (No-operation instructions) and are interpreted only by the tag processing logic.

### Fenced Protected Regions with Automatic Bounds Checking

The SP permits memory regions to be fenced with automatic bounds checking. Virtual pages containing these regions are marked as not-readable, not-writeable, so that normal memory instructions are incapable of accessing such protected regions. Only memory instructions (such as LOADs and STOREs in a RISC ISA), specifically tagged by the compiler can access these fenced regions using a specified bounds register which demarcates the memory region. Memory accesses using such tagged instructions automatically force a SP hardware check of the effective memory address to ensure that the memory accessed falls within the region specified in the bounds register. Each bounds register has the following fields:
1. a start address S indicating the starting address of the fenced region in virtual memory;
2. an offset limit L that indicates the size of the data structure. The highest accessible address in this region is S+L−1; and
3. the access mode in which this data structure can be accessed-one of: read-only, write-only, read and write.

Four such bounds registers are provided in SP, BR0 through BR3.

The information to be loaded into each bounds register is stored in two adjacent memory words tagged as “Secure Pointer 0” and “Secure Pointer 1”. The first of these two words contains the starting address of a secured data region containing sensitive data while the second word contains the segment register id of the segment containing the data, the offset limit and the access mode. The tags and contents of these words are generated at compile time and both words are immutable and unreadable by normal software. The compiler uses bounded pointers and specifically-tagged instructions, tagged [FMA] to perform secure accesses in the least privileged mode to a fenced contiguous memory region, going through an automatic bounds checking in hardware. Another special instruction tag ([LBR]) is used with a LOAD to permit secure pointers to be loaded into the specified bounds register.

Specifically, [LBR] LOAD <BRid> <reg> <offset>, tagged to indicate that this is a LOAD capable of loading a bounds register with secure pointers (tagged as [SP0] and [SP1]) is used to load the bounds register specified in <Brid> with the bounds of a fenced memory region. The effective memory address targeted by this LOAD is computed by adding the contents of an existing architected register specified in <reg> to the literal value specified in offset. The address so computed should point to a memory word tagged as “SP0”. The contents of this memory location, if the tag check passes, are loaded into the appropriate field of the specified bounds register. Next, the effective word address is incremented and should point to a memory word tagged as “SP1”. If the tag check passes, the contents are loaded into the respective fields within the specified bounds register. If either or both tag checks fail, an exception is generated. An alternative mechanism for loading, respectively, the two secure pointers (“Secure Pointer 0” and “Secure Pointer 1”) into a bounds register can use two separate LOAD instructions to load these pointers into a bounds register as follows:
[LBR0] LOAD <BRid> <reg> <offset1>
[LBR1] LOAD <BRid> <reg> <offset2>

Where the value of <offset2> is obtained by adding the value specified in <offset1 > with the size of “Secure Pointer 1”. Note also that two separate tags are used for the two LOAD instructions, LBR0 and LBR1. The hardware implementing the LOAD tagged with LBR0 checks, in addition to all other checks as described above, if the pointer type being loaded matches the tag associated with Secure Pointer 0. A similar tag check is done for the LOAD tagged with LBR1 to check compatibility with “Secure pointer 1”. The two secure pointers can have distinct associated tag values to enable this check.

To access a fenced memory region, LOAD and STORE instructions, tagged as [FMA] can access a fenced memory region. Specifically, [FMA] LOAD <reg>, <Brid> <offset> performs a load into the architectural register specified in <reg> by adding the contents of the “base” field of the bounds register specified in <BRid> and the offset. Note that in a normal LOAD instruction, the field used by <BRid> specifies an architectural register, whereas for a [FMA] LOAD, the same field specifies a bounds register. Before the memory access is actually performed, the following three checks are performed to ensure that:
the resulting word address is confined within the memory region specified in the bounds register;
if a read access is permitted as specified in the bounds register; and
the targeted memory word is tagged as readable.

An exception is generated if any of these conditions are not valid. The instruction [FMA] STORE <reg>, <BRid> <offset> is the variant of a normal STORE and is used to write to a fenced memory region after checks similar to that of a [FMA] LOAD.

### Protected Domains for Isolating Sensitive Data or Resources

Protected domains in SP encapsulate functions and sensitive data, including private data, and safeguard against unintended information leakage. Some of these functions within a protected domain are callable from external entities, including other protected domains, provided they have the appropriate privileges. These calls are cross-domain and take place through secure entry points, passing parameters through special registers. Cross-domain calls in SP use accesses to parameters passed to the called function and data inside the domain accessed by the function called in the least necessary access mode, as determined by the SP compiler or by using default policies. To complete the controlled, validated cross-domain call mechanisms, a separate call stack is used inside the protected domain as the called function executes. When the cross-domain call returns, this stack is cleared automatically to prevent any information leakage to the subsequent cross-domain calls.

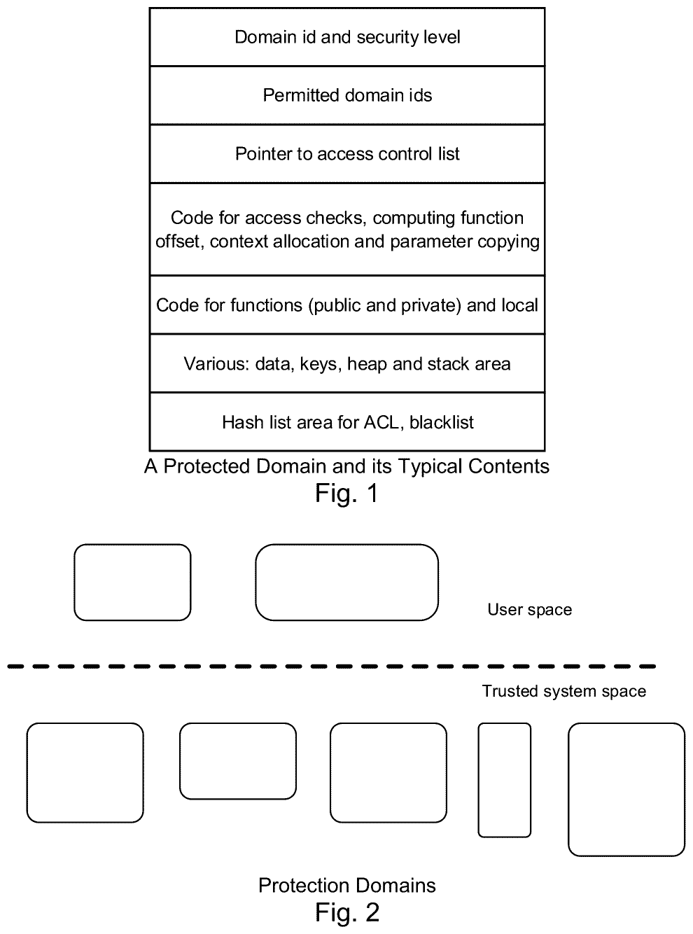

The implementation of protected domains in SP relies on the tagging mechanism. A single segment encapsulates the code for a protected domain. Domain-local data and the local stack can also be implemented within this segment. Alternatively, these structures can be implemented as fenced regions with bounded pointers, with the secure pointers stored inside the domain's code segment. The cross domain call transfers control to the callee using a protected, unresolved pointer. Data private or exclusive to the called domain are protected using fenced, bounds checking. Input parameters may be similarly protected. Legal entry points are tagged as such and all other instructions in the domain are marked as non-enterable to prevent illicit calls. In-line metadata tags are used to verify the caller's privileges on entry through these legal entry points as described below. FIG. 1 depicts the essential ingredients of a protected domain.

### Fully Isolated Protected domains

The broad mechanism described above implements a fully-isolated domain. A fully-isolated domain provides full-fledged isolation guarantees and protection, and is implemented as a segment not known and not directly accessible to the caller. Cross-domain calls use a modified system call (or a new instruction, depending on the ISA targeted), specifying an appropriately tagged domain ID and a function offset in a sealed cross-domain pointer that essentially behaves as a capability, both specified in a single word tagged as “unresolved” domain function pointer. The domain ID is translated to a segment address by an underlying trusted system call handler.

Control transfer to an isolated domain, after appropriate tag validation of the tagged and modified system calls and unresolved pointer takes place as follows.

First, the call parameters are saved in special registers and the trusted system call handler translates the domain ID to an internal address.

Next, control is transferred to the specified entry point, where access checks are performed. Subsequently, a new context (that is, call stack) is allocated to serve the call. Such context stacks can be statically or dynamically allocated [20,46] and on exit, the context pages are cleared by marking the associated tags as invalid. This clearing is necessary to prevent information in the call stack from leaking to the next caller indirectly.

To complete the protected call, after validating the legitimacy of the caller from the access control information, the input parameters are copied from the parameter register into the newly-allocated context stack and the incoming parameter registers are cleared.

The above steps indicate that the overhead of a call to a fully-isolated protection domain is relatively expensive compared to a normal function call, as domain ID translation, context allocation are needed on an entry and context clearing is needed on an exit. Parameters in a cross-domain call to a fully isolated domain are passed through special registers as scalars or as pointers to pointer secured bounded segments, whose pointers are kept in the special parameter register set. The qualifier “fully-isolated” alludes to the higher level of isolation achieved between the caller and the callee using unresolved domain pointers, separate call stacks and automatic stack clearing on exits.

From an implementation perspective, cross-domain calls to fully-isolated domains can benefit from a number of optimizations that will be explored in this effort. Examples of these optimizations include the in-lining of domain IDs of frequent callers or storing them in a local hashed data structure, use of the encryption engine within the memory controller to keep private data encrypted in memory, and decrypt them when they are fetched into the registers, or encrypt register data when they are stored into memory. Finally, the access control functions using the information in metadata can be implemented in microcode or in software, that can use an approach similar to the one for fast local exception handling described later.

### Lightweight Protected Domains

Somewhat moderate isolation can be implemented as a lightweight cross domain call where the protected domain is a segment co-mapped to the address space of the application that uses functions within the domain. A call to a function in a co-mapped domain is implemented by a JUMP instruction tagged by the compiler as a cross-domain transfer primitive. These JUMP instructions are immutable. The offset used in the JUMP is set by the compiler to the offset of a legal entry point. The address to be used is also tagged as a “resolved” domain pointer which can be only used by JUMPs tagged as a cross domain transfer instruction. The resolved domain pointers cannot be overwritten or copied, like words tagged as return addresses. They are only usable without restriction by trusted code within the system. An exception is generated if the target of the JUMP used for cross-domain call does not target a legal entry point, which has to have an instruction tagged as an entry point. Instructions within a protection domain that are not at legal entry points are tagged as “domain-sealed”. With co-mapped domains, a traditional activation stack (that is, call stack) can be used, making calls to functions within a co-mapped domain have an overhead identical to a normal function call.

### Protected Domains

Critical systems functions and critical databases are examples of entities that demand the use of a fully-isolated domain for protection. FIG. 2 depicts a setup where multiple domains exist within the user and system space.

Protection domains represent a way of implementing security compartments that contain executable code. Access to the code within a compartment is enabled through predefined entry points and only if the caller has the right access privileges. From the usage perspective, the choice between a lightweight domain and a fully-isolated domain is determined largely by the level of isolation needed.

The SP permits one or more protection domains to be set up within the user space or within the systems space as shown in FIG. 2. Domains in SP are functionally identical whether they are in the user space or system space. A single application may be written to incorporate multiple protection domains in the user space. Similarly, the OS itself can be decomposed into multiple domains.

A simple decomposition breaks down the system into domains corresponding to core kernel functions, other kernel function, trusted tag manipulation module, system calls, Virtual Machine Monitor (VMM), individual libraries, individual utilities such as trusted linkers, trusted loaders, trusted compilers, etc. The hardware support is required to implement and enforce the address limits of the domain, confining address calculations performed with a segment base register in the virtual address to addresses within the domain.

### Fast Local Exception Handling

In some cases, security checks can be quite elaborate and need to be performed in software. Such checks can be done using a function local to a protection domain that can be invoked with low overhead on a tag-generated exception. The existence of a local trap is indicated by inserting a metadata tag, preceding the code that uses the data, to indicate that a local handler exists for specific exception types. The in-lined metadata words at the beginning of this function where the exception is generated, passes on the address of the handling function and the type of exception it handles, to the underlying SP control logic. When the function generating the exception returns, the local exception function is disabled by another metadata tag (tagged [EMD]) inserted by the compiler to precede the return instruction, reverting exception handling responsibilities to the system-provided handler.

RAKSHA [13] also provides local handlers, but in the SP according to the present technology, their scope is additionally limited only to the function where they are specified for added security. Local exception handling for security checks can be used for dealing with SQL injection.

### Keeping Track of Lowest Privileges In a Protected Call Chain

A call to a protected domain performs the necessary access checks, but it may be useful in some situations to keep track of the lowest privileged domain in the call chain. This information is passed on to the callee through an extension of the cross-domain parameter transfer register and saved in the context stack allocated for the call. With a dynamic, privilege-based security policy, where policies need to be changed on-the-fly, the privilege level of the protected domain with the lowest privilege in the call chain can be used in software to identify and deal with any unintended violation.

More generally, the tag in each case may be arbitrarily extensible through reference to an optional additional tag, register, stack entry, or memory location. Thus, the tag may be limited to 8 bits, but include “extensions” as required.

### Crypto Engine and Per-Thread Key Registers

To permit fast encryption and decryption in the memory access path for data going out to memory or fetched from encrypted memory regions, the SP may incorporate a memory encryption and decryption engine within the memory controller. Memory access instructions (such as LOADs and STOREs) tagged as [ENC] may invoke memory encryption or decryption when a line is fetched from memory or written to memory.

This cryptographic processing capability may be used for other features, and thus need not be dedicated to the SP functionality only, though preferably the cryptographic key(s) used for SP is distinct from key(s) used for other purposes. Likewise, key management for the SP functionality key(s) is restricted to hardware and/or specially privileged software.

For example, memory writes to cache lines that need to be encrypted before being written to memory are marked within the cache using a bit flag and encryption takes place when such lines are evicted from the cache. This flag accompanies the line to the memory write buffer and is examined by the memory controller to decide if the line needs to be encrypted prior to the write.

The SP also incorporates a per-thread key register that is used to hold the key for the encryption. The key registers are loaded by a trusted kernel module when the thread is scheduled.

The present approach provides cryptographic protection in two areas: software requested cryptographic operations and cryptography embedded in the hardware to support the SP architecture tag and data security. A cryptographic block is provided for software use. The software cryptographic engine block enforces protocol compliance to eliminate common misuse of cryptographic operations. Cryptographic keys are isolated from software access and provide the capability to generate unique power-on keys to protect data at rest.

The embedded cryptographic processing utilizes high speed encryption/decryption engines and hash capabilities for protecting the various tags and vulnerable memory areas defined in the SP architecture from modification and inadvertent data exposure. In addition, the solution provides flexibility for future enhancements by enabling integration of commercial Physically Unclonable Functions (PUFs) to provide unique per part protection, verification and authentication of data. This combination of enhancements is utilized to eliminate attacks on the cryptographic operations.

### Memory Mapped IO Devices and Taint Tagging

The SP maps all IO device registers to the memory space and protects accesses to them using special tags [MCM, MCI]. For added protection, these can be private to drivers that are implemented as a protected domain.

The SP also implements taint propagation. Any IO device that can import potentially suspect data performs the DMAs into area word-tagged as [INV], or invalid. Any use of such data triggers exceptions that validates the data type in software, and once validated, copies it into the appropriate memory locations with proper tags. Byte sequences coming in from potentially compromised sources, such as a network interface, will be stored as a sequence of words tagged with [TBS] or, as a potentially tainted byte string components, with null byte pads to round up to a word size. Any operation using an input tagged as [INV] or [TBS] propagates the same tag to the result (both value and flags such as carry, zero, etc.). Overflows, underflows and results produced using inappropriate types of input operands will also taint the result produced by tagging it as [INV].

### Specific SP Example

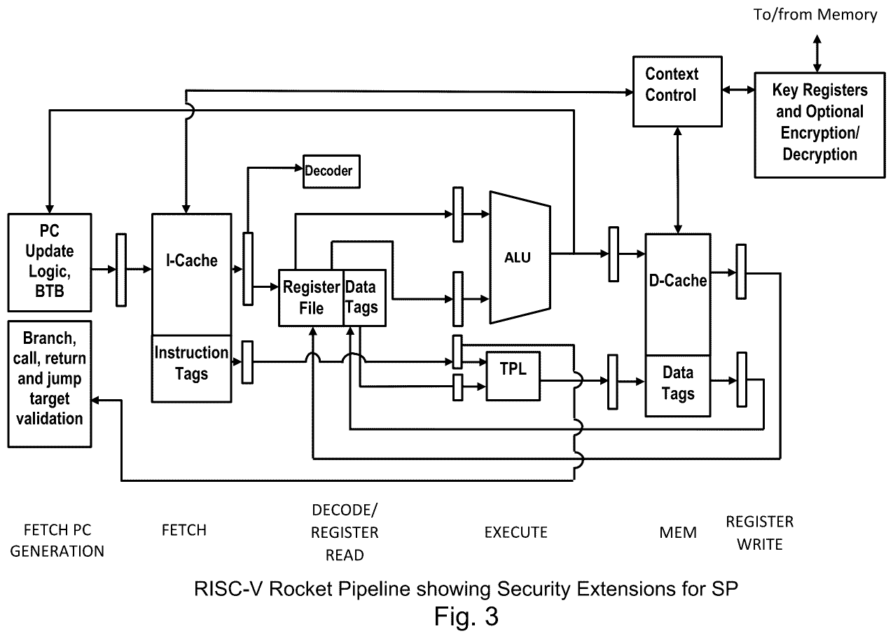

FIG. 3 shows an embodiment of a simple pipelined processor (the RISC-V Rocket implementation) with hardware extensions for realizing the SP pipeline design, including the branch, call, return and jump target validation, instruction tags, data tags, tag processing log (TPL), context control, key registers and optional encryption/decryption, as well as the latches associated with them (unlabeled boxes) in between adjacent pipeline stages Extended registers may also include bounds registers, parameter registers for cross-domain calls and the local handler address register. TPL is the tag processing logic for operations. The cryptographic engine can encrypt/decrypt data or pass data through without encryption/decryption. The tag storage and the tag processing components and latches can be implemented in a separate parallel pipeline.

Tags and data or code are all stored in their respective pages. Accesses to a data or instruction word requires the corresponding tag to be fetched, thus doubling the number of memory accesses needed. The performance penalty that results is mitigated by using extensions (Itag$ and Dtag$) to the instruction (I$) and data cache (D$) to hold the tags corresponding to a cache line, noting that accesses to tags exhibit the same localities seen in the course of accessing instructions and data. The impact of using tag caching was simulated on the Simplescalar simulator for an Alphas ISA (which is representative) with 32 Kbyte instruction and data caches, extended to hold tags and with a 256K unified L2 cache holding data, instruction and tag lines. Across the benchmarks in the SPEC benchmark suite, the extra memory accesses needed for word tags impose a performance penalty of less than 2% to a maximum of 19%, with an average penalty of about 10.5%. This can be reduced with other optimizations such as word tag prefetching and page-level tag consolidation into the TLB entries of pages with immutable and homogeneous contents. The additional energy overhead of word tag accesses can be reduced by using line buffering [21], which keeps recently-accessed cache rows in a few buffers external to the cache tag and data arrays, preventing unnecessary discharges of the pre-charged bit lines in the cache tag and data arrays on a hit in the line buffers in a direct silicon implementation or avoiding a read of the RAM-implemented data ways in a FPGA implementation, saving energy. This technique imposes no penalty on the cache access time and can also be used on the normal caches to stay within a reasonable power budget.

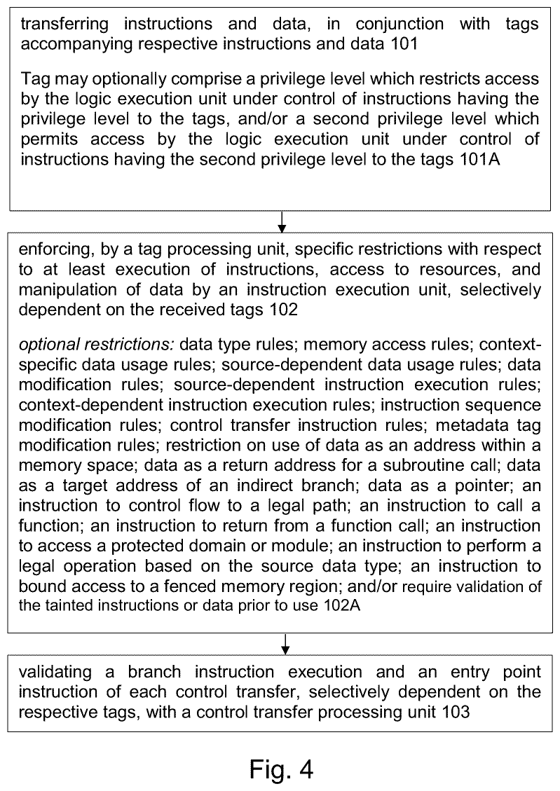

FIG. 4 shows a flowchart of a method of operating the secure processor in accordance with an embodiment of the invention.

Instructions and data are transferred, in conjunction with tags accompanying respective instructions and data 101. Tag may optionally comprise a privilege level which restricts access by the logic execution unit under control of instructions having the privilege level to the tags, and/or a second privilege level which permits access by the logic execution unit under control of instructions having the second privilege level to the tags 101A.

A tag processing unit enforces specific restrictions with respect to at least execution of instructions, access to resources, and manipulation of data by an instruction execution unit, selectively dependent on the received tags 102. The tag processing unit may ensure compliance with data type rules; memory access rules; context-specific data usage rules; source-dependent data usage rules; data modification rules; source-dependent instruction execution rules; context-dependent instruction execution rules; instruction sequence modification rules; control transfer instruction rules; and/or metadata tag modification rules. The tag processing unit may enforce a restriction on use of data as an address within a memory space; data as a return address for a subroutine call; data as a target address of an indirect branch; data as a pointer; an instruction to control flow to a legal path; an instruction to call a function; an instruction to return from a function call; an instruction to access a protected domain or module; an instruction to perform a legal operation based on the source data type; and/or an instruction to bound access to a fenced memory region 102A.

A branch instruction execution and an entry point instruction of each control transfer are validated, selectively dependent on the respective tags, with a control transfer processing unit 103.

### Security Provided by SP

The SP relies fundamentally on the integrity of the word-tagging mechanism and in-line metatags (which are also word-tagged). This is realized by making tags inaccessible to software. The only exception to this is a high-privilege trusted software module that can manipulate the tags. SP also assumes that the compiler, linker and loader are trusted, as the compiler is responsible for the tag generation and the linker and loader are responsible for loading the word tags in a secure memory area inaccessible to all but the trusted software module that can manipulate tags. The hardware, of course, is also assumed to be secure as it interprets the tags. Attacks during booting or tag loading by induced interrupts that can potentially corrupt the tags are addressed by validating the hash signature of the tag pages prior to execution.

Instruction tagging in the SP, to enforce their context-dependent legal use, a distinctive feature of the SP, provides the basis for enforcing control flow for functions calls and returns and for directing indirect jumps to legal targets. The SP also disallows data to be interpreted as instruction-this is the basis for preventing several attacks. At the same time, to permit legal code modifications in interpreters and during the boot loading of some OSs, the functions performing such modifications are vetted out and validated at run-time using tags.

Data areas secured with bounds checking and accessed in the least-necessary access modes use secure pointers and specially-tagged memory instructions, making it impossible for normal memory instructions to access such fenced areas, which are implemented in pages marked as non-readable and non-writeable (and non-executable).

Protection Domains (PDs) in the SP for encapsulating data, associated private and public functions, are invoked only through compiler-directed control instructions (tagged as such) and invoke domain functions through legal entry points by ensuring that the control transfer to such domains from the caller take place at instructions tagged as entry points. PDs are entered only after validating the eligibility of the caller at the entry point using in-line metadata tags that point to access control information or has embedded access control information. This guarantees that only legitimate callers can invoke the PD's public functions. PDs allocate a call-specific context (call stack) on each call and can also use optional encryption for any private data in the RAM, facilitated by a master key maintained in the per-thread key register and memory encryption/de-encryption engine. All of these features permit PDs to implement security compartments and guard against unintended data leakage.

### Examples of Security Provided by SP Against Software Vulnerabilities

The protection provided by the SP may be provided against instances of weaknesses from various CWE (Common Weakness Enumeration) classes as listed by Mitre Corporation.

The following table lists how exemplary instances of the seven classes of CWEs are handled in SP. Tags are shown, where used in square brackets. Additionally, the SP compiler avoids vulnerabilities by using proper libraries, vetted functions and trusted system functions. Example details on how SP handles some vulnerability classes is discussed below.

### Buffer Errors

In SP, buffer errors are avoided by using protected fenced memory regions in general. In buffer overflow attacks that center on a stack and compromise function call and return control flow, word and instruction tags detect control flow compromises as follows. The key idea here is to enforce that the return from a function uses a legitimate return address from the call stack and that control returns to the instruction immediately following the call instruction (implemented using a JALR or JAL on the RISC-V). The SP accomplishes this as follows:

The control logic implementing a Call instruction is augmented to tag the return address pushed onto the call stack as a “return” address. The return address tag is generated only by the Call instruction. The return address tag also marks the word as immutable (that is not overwriteable) and permits only a return instruction (tagged appropriately) to use this return address. Word tagged as a return address cannot also be copied (for instance by using a LOAD).

The instruction following a call, which is the point of return, is tagged by the compiler as the target of a return.

The Return instruction or the JUMP instruction implementing a function call return is tagged as a “return” instruction by the compiler.

Control flow returns only when the target address on the call stack is marked as a return address and the next instruction executed is marked as the target of a return. A successfully executed return also resets the stack location associated with the return address used to permit overwrites during subsequent usage.

For relocation of stacks and context switches, tag checking is turned off momentarily by a trusted code and stack words, including words tagged as a return address can be copied and written elsewhere.

This simple data word-tagging and instruction-tagging mechanism prevents the simple “stack smashing” attacks as well as libc attacks [40], and more sophisticated return-oriented programming attacks [27]that all use buffer overruns to overwrite return addresses on the attack. Overwrites to stack locations that hold the return address are prevented, and raise an exception because of the “return” address tag, which prevents overwrites and copying. Further, for libc and ROP attacks, arbitrary gadgets cannot be constructed, as the instruction at the point of the misdirected return is not tagged as a legitimate instruction following a call by the compiler in general.

The tag-based implementation of proper function call and return control flow has significant advantages compared to shadow stacks that provide similar functionality (for example, as recently introduced by Intel [29]). The shadow stack mechanism essentially saves the return address at the time of a call on a separate shadow stack. At the time of a return, the return address used for the normal call stack is compared against the return address saved on the shadow stack and an exception is triggered on a mismatch. The shadow stack needs to be implemented in a protected area and also needs to be saved and restored on context switches. SP eliminates the need to implement and manage a shadow stack across context switches. The mechanism also imposes zero performance overhead (i.e., the protection mechanism does not add any execution overhead when the security checks pass, other than the performance degradation caused by additional accesses to tags, which are mitigated using the encoded tag cache hierarchy and tag perfecting), and is far less complicated than exotic architectural support that has been proposed for detecting ROP attacks [4, 5, 31].

### Enforcing Control Flow for Indirect/Computed Branches

The legal targets of an indirect jump are all tagged as such at compile time. When an indirect jump executes, the tag of the target is verified to be marked as a target for the indirect branch; an exception is generated if the indirect branch attempts to transfer control to any instruction that is not marked as a target. Jump-oriented programming attacks that construct attack gadgets by stringing together existing instruction chunks through the modification of targets of indirect jumps [6] are thus not possible. Again, the SP is far simpler compared to proposed solutions like [4, 5], or the use of special instructions at the target of indirect branches, as in a recent Intel solution [29], and has a zero performance overhead.

Note that with the SP tagging scheme, it is still possible for an indirect jump to legally transfer control to the marked target of another indirect jump. Although this would be a relatively difficult exploit, the SP can protect against this by storing an in-line metadata tag at the target that holds a unique-compiler-generated label derived from the indirect branch's virtual address. This metadata-bearing word is followed by the original instruction at the target. Control transfer is allowed only after validating this label and ensuring that the jump target is labeled as a legitimate target. This approach is similar to what has been used for enforcing control flow integrity in software [1].

### Protecting Transfer Vectors and Function Pointer Tables

A class of attacks redirect control flow from the intended path by altering the address of virtual functions used by many programming languages (for example, Vtable attacks for C++ programs) or jump vectors stored in jump tables by the linker for dynamically linked code modules. Tagging these table entries as immutable jump table entry prevents them from being overwritten by malicious code and also ensures their proper use by jump instructions.

### Preserving Code Integrity

At the page level, data segments have an associated NX (no-execute flag) for each page within the segment. In addition, instructions are tagged as immutable by the compiler, so they cannot be altered. Together, these mechanisms ensure code integrity is preserved. However, there are legitimate reasons for using run-time code modification in current systems. Many OSs use self-modifying code at boot time for booting off a small image. Similarly, bytecode interpreters in languages such as Java rely on code modification for performance optimization. A solution to permitting these undesirable legacy practices is to validate the code that performs this on-the-fly modification, and rely on the trusted software module that can directly access and update the tags before and after modification. To do this, the permitted functions that modify the binaries at run-time are implemented within their own protection domain and they are permitted to call functions within the domain runs the functions that perform the code modifications. This permission is granted through explicit entries in an access control list for the protection domain that implements the tag updates.

### SQL Injection and Cross-Domain Scripting

Both SQL injection and cross-domain scripting vulnerabilities stem from the use of potentially tainted inputs. The SP marks such inputs as tainted with the word tag [TAI]. Byte sequences are put into words, and the constituent words bear this tag. The SP does not rely on hardware to perform the validation of arguments, as the process is very complex. Instead, any attempt to use such tainted arguments trigger a context-specific check by a handler. In some cases, the handler may be encapsulated in the domain where the argument is processed or used, and is invoked through a locally-handled trap as a function call with low overhead. As an example in the case of SQL injection, the SQL database and its associated functions can be encapsulated in a protection domain with a handler to check the byte string passed on as argument. On exit from the validation function (which will typically call trusted functions for validating the argument as legal, for example using SQL whitelists and/or blacklists and other mechanisms), normal exception handling is automatically restored.

### General Implementation of the Security Extensions

The SP technologies are implementation-agnostic across many RISC ISAs. The narrow tags and in-line metadata tags facilitate this. Extending tag storage to instruction and data caches facilitate the performance scaling, along with use of known techniques for mitigating the overhead of tag accesses. It is worth noting that the SP system, as described herein, does not use all of the 256 tag values that are possible with 8-bit word tags. This permits other tag values to be used in ways that can evolve as the SP design matures during or beyond the project, and other extensions consistent with the SP architecture or independent of it.

The access control policies used for protection domains in SP are also very flexible, as the access control code can be implemented in software within trusted handlers that can be invoked quickly as a local handler. Thus, SP's security architecture provides flexibility in the design and use of tags, as well as in crafting a variety of security policies.

In the SP, the code associated with protection domains is designed to support multithreading and SMP (multicore) implementations. Utilities for SP are also designed to be thread-safe. Cross-domain parameter passing registers, bounds, special registers containing a local handler address(es), and tags associated with general-purpose registers in the ISA, have to be all part of the context of a process/thread and need to be saved on context switches. Extending the tags to the instruction and data caches permit exiting cache coherence mechanisms to be easily used for SP for multicore implementations with cache coherence logic.

For CISC ISAs like the ×86, variable-length instructions do impose an addressing challenge for the instruction tags in separate pages from the code. The solution to be used for incorporating the SP security mechanism for detecting software vulnerability exploits relies on instructions being non-writable, and stores instructions adjacent to their tags, and the instruction decoder is modified to take the (uniform-sized) instruction tags into account. The compiler also takes into account the tag size for generating the offsets used in PC-relative addressing.

It is also possible to use 4-bit encoded tags for SP, which makes it easy to pad memory lines containing instruction tags and simplify instruction tag addressing. There are many specific optimizations that can reduce the performance overhead of a ×86 CPU including the SP security mechanisms, compared to the baseline traditional implementation.

For example, micro-op (uop) trace caches used in many ×86 implementations, which contain validated traces and security checks (and associated performance delays and power dissipations), can be avoided when the trace is re-executed and other performance boosting artifacts built around trace caches (such as group commitment) can be used.

### REFERENCES

Each of the following is expressly incorporated herein by reference in its entirety.
[1] Abadi, M., M. Budiu, Ú. Erlingsson, and J. Ligatti, “Control-flow Integrity”, in Proceedings of the 12th ACM Conference on Computer and Communications Security, pp. 340-353. ACM, 2005.
[2] Air Force Research Laboratory Report No. AFRL-RI-RS-TR-2015-210, Security-Tagged Architecture Co-Design (STACD), September 2015.
[3] Air Force Research Laboratory, Publicly-released information on the T-Core project, provided by J. Rooks, in email to J. Kiernan at Lockheed-Martin, May 19, 2017.
[4] Aktas, E., F. Afram, K. Ghose, “Continuous, Low Overhead, Run-Time Validation of Program Executions”, in IEEE Proceedings of the 47th Annual Symposium on Microarchitecture (MICRO), (2014), pp. 229-241.
[5] Arora, D., Ravi, S., Raghunathan, A., and Jha, N. K. “Hardware-assisted run-time monitoring for secure program execution on embedded processors.” IEEE Transactions on Very Large Scale Integration (VLSI) Systems 14, no. 12 (2006): 1295-1308.
[6] Bletsch T., X. Jiang, V. W. Freeh, Z. Liang, “Jump oriented programming: a new class of code-reuse attack”, In Proc. of the 6th ACM Symposium on Information, Computer and Communications Security. ASIACCS, pp. 30-40, 2011.
[7] Chen, Y.-Y., P. A. Jamkhedkar, and R. B. Lee, “A Software Hardware Architecture for Self-Protecting Data”, in Proceedings of the ACM Conference on Computer and Communications Security, pp. 14-27. ACM, 2012.
[8] Cheng, B.-C., and W.-M. Hwu, “Modular Interprocedural Pointer Analysis using Access Paths: Design, Implementation, and Evaluation”, in ACM SIGPLAN Notices 35, no. 5 (2000), pp. 57-69.
[9] Choi, J.-D., M. Burke, and P. Carini. “Efficient Flow-sensitive Interprocedural Computation of Pointer-induced Aliases and Side effects”, in Proceedings of the 20th ACM SIGPLAN-SIGACT symposium on Principles of programming languages, pp. 232-245, 1993.
[10] Costan, V, Ilia Lebedev, and Srinivas Devadas, “Sanctum: Minimal Hardware Extensions for Strong Software Isolation”, in Proceedings of the 25th Usenix Security Symposium, 2016, pp. 857-874.
[11] Costan, V. and Srinivas Devadas, “Intel SGX Explained”, Cryptology ePrint Archive, Report 2016/086, February 2016.
[12] Crandall, J. R. and F. T. Chong, “MINOS: Control Data Attack Prevention Orthogonal to Memory Model”, in Proceedings of the 37th Intl. Symposium on Microarchitecture, Portland, OR, December 2004.
[13] Dalton, M., H. Kannan, and C. Kozyrakis, “Raksha: A Flexible Information Flow Architecture for Software Security”, in Proceedings of the International Symposium on Computer Architecture (ISCA), pp. 482-493, 2007.
[14] De Moura, L., and N. Bjørner, “Z3: An efficient SMT solver”, in Proceedings of International conference on Tools and Algorithms for the Construction and Analysis of Systems, pp. 337-340, 2008.
[15] Dhawan, U., C. Hritcu, R. Rubin, N. Vasilakis, S. Chiricescu, J. M. Smith, T. F. Knight, Jr., B. C. Pierce and A. DeHon, “Architectural Support for Software-Defined Metadata Processing”, in Proceedings of the 20-th International Conference on Architectural Support for Programmin Languages and Operating Systems, pp. 487-502, 2015.
[16] Emami, M., R. Ghiya, and L. J. Hendren. “Context-Sensitive Interprocedural Points-to Analysis in the Presence of Function Pointers, in ACM SIGPLAN Notices, vol. 29, no. 6, pp. 242-256, 1994.
[17] Evtyushkin, D. E., J. Elwell, M. Ozsoy, D. Ponomarev, N. Abu-Ghazaleh and R. Riley, “Iso-X: A Flexible Architecture for Hardware-Managed Isolated Execution”, in Proceedings of the 47-th Annual Symposium on Microarchitecture (MICRO), (2014), pp. 190-202. IEEE.
[18] Fahndrich, M., J. S. Foster, Z. Su, and A. Aiken, “Partial Online Cycle Elimination in Inclusion Constraint Graphs”, in Proceedings Proceedings of the ACM SIGPLAN Conference on Programming Language Design and Implementation (PLDI '98), pp. 85-96, 1998.
[19] Feustel, Edward A, “On the Advantages of Tagged Architectures”, in IEEE Transactions on Computers, Vol. 22 (7), pp. 644-652, July 1973.
[20] Ghose K. and P. Vasek, “A Fast Capability Extension to a RISC Architecture”, in Proceedings of the EUROMICRO Conference, September 1996, pp. 606-614.
[21] Ghose, K. and M. B. Kamble, “Reducing Power in Superscalar Processor Caches using Subbanking, Multiple Line Buffers and Bit-line segmentation”, in Proceedings of the 1999 international symposium on Low Power Electronics and Design (ISLPED '99), pp. 70-75, 1999.
[22] Graham, B, Protection in an Information Processing Utility, in Communications of the ACM, Volume 11, pp. 306-312, May 1968.
[23] Halfond, W. G. J., and A. Orso, “AMNESIA: Analysis and Monitoring for NEutralizing SQL-Injection Attacks”, in Proceedings of the 20th IEEE/ACM international Conference on Automated Software Engineering (ASE '05), pp. 174-183, 2005.
[24] Hardekopf, B., and C. Lin, “The Ant and the Grasshopper: Fast and Accurate Pointer Analysis for Millions of Lines of Code”, in ACM SIGPLAN Notices, vol. 42, no. 6, pp. 290-299, 2007.
[25] Heintze, N., and O. Tardieu, “Ultra-fast Aliasing Analysis using CLA: A Million Lines of C Code in a Second”, in ACM SIGPLAN Notices, vol. 36, no. 5, pp. 254-263, 2001.
[26] Houdek, M.E., F. G. Soltis, and R. L. Hoffman, “IBM System/38 Support for Capability-based Addressing”, in Proceedings of the Eighth Annual Symposium on Computer Architecture, pp. 341-348, 1981.
[27] Hund R., T. Holz and F. Freiling, “Return oriented rootkits: Bypassing kernel code integrity protection mechanisms”, in Proc. of Usenix Security Symposium, pp. 383-398, 2009.
[28] Intel Corporation., Intel Memory Protection Extensions Enabling Guide, software.intel.com/sites/default/files/managed/9d/f6/Intel_MPX_EnablingGuide.pdf Accessed: 2017 May 30.
[29] Intel Corporation, Control-flow Enforcement Technology Preview, Document Number: 334525-001, June 2016.
[30] Intel Corporation, Introduction to the iAPX 432 Architecture, Manual No. 171821-001, 1981.
[31] Kayaalp M., Ozsoy M., Abu-Ghazalch N., Ponomarev D., “Branch Regulation: Low Overhead Protection Fron Code Reuse Attacks”, 39th Int'l. Symp. on Computer Architecture (ISCA), pp. 94-105, 2012.
[32] Landi, W., and B. G. Ryder. “A Safe Approximate Algorithm for Interprocedural Pointer Aliasing”, ACM SIGPLAN Notices 39, no. 4 (2004), pp. 473-489.
[33] Levy, H. M., Capability-Based Computer Systems, Digital Press, 1984.
[34] McKeen, F., I. Alexandrovich, A. Berenzon, C. Rozas, H. Shafi, V. Shanbhogue, and U. R. Savagaonkar, “Innovative Instructions and Software Model for Isolated Execution”, in Proceedings of the Workshop on Hardware and Architectural Support for Security and Privacy (HASP), pp. 10:1-10:8, 2013.
[35] Moon, D. A., “Architecture of the Symbolics 3600”, in Proceedings of the 12th. Annual International Symposium on Computer Architecture, ISCA, pp. 76-83, 1985. IEEE Computer Society.
[36] Nystrom, Erik, Hong-Seok Kim, and Wen-Mei Hwu. “Bottom-up and Top-down Context-sensitive Summary-based Pointer Analysis.” Static Analysis, pp. 165-180, 2004.
[37] Organick, E. I, Computer System Organization: The B5700/B6700 Series, Academic Press, 1973.
[38] Pietraszek, T. and C. V. Berghe, “Defending Against Injection Attacks through Context-Sensitive String Evaluation”, in Proceedings of the Recent Advances in Intrusion Detection Symposium, Seattle, WA, September 2005.
[39] Qin, F., C. Wang, Z. Li, H. Seop Kim, Y. Zhou, and Y. Wu, “LIFT: A Low-Overhead Practical Information Flow Tracking System for Detecting Security Attacks”, in Proceedings of the 39th the Intl. Symposium on Microarchitecture, Orlando, FL, December 2006.
[40] Shacham H. “The Geometry of Innocent Flesh on the Bone: Return-into-libc without Function Calls (on the ×86)”, In14th The ACM Conference on Computer and Communications Security (CCS), pp. 552-561, 2007.
[41] Shioya, R., D. Kim, K. Horio, M. Goshima, and S. Sakai, Low-overhead Architecture for Security Tag, in Proceedings of the 2009 15th IEEE Pacific Rim International Symposium on Dependable DComputing, PRDC '09, pages 135-142, Washington, DC, USA, 2009. IEEE Computer Society.
[42] Suh, G. E., J. W. Lec, D. Zhang, and S. Devadas., “Secure Program Execution via Dynamic Information Flow Tracking”, in Proceedings of the 11th Intl. Conference on Architectural Support for Programming Languages and Operating Systems, Boston, MA, October 2004, In ACM Sigplan Notices, vol. 39, no. 11, pp. 85-96. ACM, 2004.
[43] Sui, Y., and J. Xue. “SVF: Interprocedural Static Value-flow Analysis in LLVM”, in Proceedings of the 25th ACM International Conference on Compiler Construction, pp. 265-266, 2016.
[44] Sullivan, G., “The Dover Architecture”, presentation at New England Security Day, Nov. 28, 2016
[45] Vachharajani, N., M. J. Bridges, J. Chang, R. Rangan, G. Ottoni, J. A. Blome, G. A. Reis, M. Vachharajani, and D. I. August, “RIFLE: An Architectural Framework for User-Centric Information-Flow Security”, in Proceedings of the 37th Intl. Symposium on Microarchitecture, Portland, OR, December 2004.
[46] Vasek, P. and K. Ghose, “A Comparison of Two Context Allocation Approaches for Fast Protected Calls”, in Proceedings of the IEEE Conference on High-Performance Computing (HiPC), December 1997, pp. 16-21.
[47] Whaley, J., and M. S. Lam. “Cloning-based Context-Sensitive Pointer Alias Analysis Using Binary Decision Diagrams”, in ACM SIGPLAN Notices, vol. 39, no. 6, pp. 131-144, 2004.
[48] Witchel, E., J. Cates, and K. Asanovic, “Mondrian Memory Protection”, in Proceedings of the 10th International Conference on Architectural Support for Programming Languages and Operating Systems, ASPLOS X, Vol. 37, no. 10. pp. 304-316, New York, NY, USA, 2002. ACM.
[49] Woodruff, J., R. N. Watson, D. Chisnall, S. W. Moore, J. Anderson, B. Davis, B. Laurie, P. G. Neumann, R. Norton and M. Roe, “The CHERI Capability Model: Revisiting RISC in an Age of Risk”, in Proceedings of the International Symposium on Computer Architecture (ISCA), pages 457-468, June 2014.
[50] Wulf, W. A., S. P. Levin and S. P. Harbison, Hydra/Cmmp: An Experimental Computer System, McGraw-Hill, 1981.
[51] Xu, W., S. Bhatkar, and R. Sekar, “Taint-enhanced Policy Enforcement: A Practical Approach to Defeat a Wide Range of Attacks”, in Proceedings of the 15th USENIX Security Conference, Vancouver, Canada, August 2006.
[52] Zhu, J., “Towards Scalable Flow and Context Sensitive Pointer Analysis”, in Proceedings of the 42nd annual Design Automation Conference, pp. 831-836, 2005.
[53] Achermann, Reto, Chris Dalton, Paolo Faraboschi, Moritz Hoffmann, Dejan Milojicic, Geoffrey Ndu, Alexander Richardson, Timothy Roscoe, Adrian L. Shaw, and Robert N M Watson. “Separating Translation from Protection in Address Spaces with Dynamic Remapping.” In Proceedings of the 16th Workshop on Hot Topics in Operating Systems, pp. 118-124. ACM, 2017.
[54] Aga, Shaizeen, and Satish Narayanasamy. “InvisiMem: Smart memory defenses for memory bus side channel.” In ACM SIGARCH Computer Architecture News, vol. 45, no. 2, pp. 94-106. ACM, 2017.
[55] Arora, Divya, Srivaths Ravi, Anand Raghunathan, and Niraj K. Jha. “Secure embedded processing through hardware-assisted run-time monitoring.” In Design, Automation and Test in Europe, 2005. Proceedings, pp. 178-183. IEEE, 2005.
[56] Belay, Adam, Andrea Bittau, Ali José Mashtizadeh, David Terei, David Mazières, and Christos Kozyrakis. “Dune: Safe User-level Access to Privileged CPU Features.” In Osdi, vol. 12, pp. 335-348. 2012.
[57] Chen, Chun-Chung, Shih-Hao Hung, and Chen-Pang Lee. “Protection against Buffer Overflow Attacks via Dynamic Binary Translation.” In Reliable and Autonomous Computational Science, pp. 305-324. Springer, Basel, 2011.
[58] Chien, Andrew A., and Jay H. Byun. “Safe and protected execution for the morph/AMRM reconfigurable processor.” In Field-Programmable Custom Computing Machines, 1999. FCCM'99. Proceedings. Seventh Annual IEEE Symposium on, pp. 209-221. IEEE, 1999.
[59] Corliss, Marc L., E. Christopher Lewis, and Amir Roth. “DISE: A programmable macro engine for customizing applications.” In Computer Architecture, 2003. Proceedings. 30th Annual International Symposium on, pp. 362-373. IEEE, 2003.
[60] Cox, Benjamin, David Evans, Adrian Filipi, Jonathan Rowanhill, Wei Hu, Jack Davidson, John Knight, Anh Nguyen-Tuong, and Jason Hiser. “15th USENIX Security Symposium.”
[51] Dagit, Jason, Simon Winwood, Jem Berkes, and Adam Wick. “Code re-use attacks and their mitigation.” (2017).
[62] Ferraiuolo, Andrew, Mark Zhao, Andrew C. Myers, and G. Edward Suh. “HyperFlow: A processor architecture for nonmalleable, timing-safe information flow security.” In Proceedings of the 2018 ACM SIGSAC Conference on Computer and Communications Security, pp. 1583-1600. ACM, 2018.
[63] Ferraiuolo, Andrew, Yuqi Zhao, G. Edward Suh, and Andrew C. Myers. HyperFlow: A Processor Architecture for Timing-Safe Information-Flow Security. 2018.
[64] Fu, Jianming, Rui Jin, and Yan Lin. “FRProtector: Defeating Control Flow Hijacking Through Function-Level Randomization and Transfer Protection.” In International Conference on Security and Privacy in Communication Systems, pp. 659-672. Springer, Cham, 2017.
[65] González, Julián A. “Hardware Modifications to Prevent Code Reuse Attacks.” (2014).
[66] Havet, Aurélien, Rafael Pires, Pascal Felber, Marcelo Pasin, Romain Rouvoy, and Valerio Schiavoni. “SecureStreams: A Reactive Middleware Framework for Secure Data Stream Processing.” In Proceedings of the 11th ACM International Conference on Distributed and Event-based Systems, pp. 124-133. ACM, 2017.
[67] Hoefler, Torsten, Salvatore Di Girolamo, Konstantin Taranov, Ryan E. Grant, and Ron Brightwell. “sPIN: High-performance streaming Processing in the Network.” In Proceedings of the International Conference for High Performance Computing, Networking, Storage and Analysis, p. 59. ACM, 2017.
[68] Joannou, Alexandre, Jonathan Woodruff, Robert Kovacsics, Simon W. Moore, Alex Bradbury, Hongyan Xia, Robert NM Watson et al. “Efficient Tagged Memory.” In Computer Design (ICCD), 2017 IEEE International Conference on, pp. 641-648. IEEE, 2017.
[69] Jungwirth, Patrick, Phil Chan, Eric Imsand, and Hameed Badawy. “Security tag computation and propagation in OSFA.” In Cyber Sensing 2018, vol. 10630, p. 1063004. International Society for Optics and Photonics, 2018.
[70] Jungwirth, Patrick, Philip Chan, Thomas Barnett, and Abdel-Hameed Badawy. “Cyber defense through hardware security.” In Disruptive Technologies in Information Sciences, vol. 10652, p. 106520P. International Society for Optics and Photonics, 2018.
[71] Kannan, Hari, Michael Dalton, and Christos Kozyrakis. “Decoupling dynamic information flow tracking with a dedicated coprocessor.” In Dependable Systems & Networks, 2009. DSN'09. IEEE/IFIP International Conference on, pp. 105-114. IEEE, 2009.
[72] Kim, Channoh, Jachycok Kim, Sungmin Kim, Dooyoung Kim, Namho Kim, Gitac Na, Young H. Oh, Hyeon Gyu Cho, and Jae W. Lec. “Typed Architectures: Architectural Support for Lightweight Scripting.” ACM SIGOPS Operating Systems Review 51, no. 2 (2017): 77-90.
[73] Lentz, Matthew, Rijurekha Sen, Peter Druschel, and Bobby Bhattacharjec. “ScCloak: ARM Trustzone-based Mobile Peripheral Control.” (2018).
[74] Lie, David, Chandramohan Thekkath, Mark Mitchell, Patrick Lincoln, Dan Bonch, John Mitchell, and Mark Horowitz. “Architectural support for copy and tamper resistant software.” ACM SIGPLAN Notices 35, no. 11 (2000): 168-177.
[75] Liu, Tao, Hui Guo, Sri Parameswaran, and Sharon X. Hu. “iCETD: An improved tag generation design for memory data authentication in embedded processor systems.” Integration, the VLSI Journal 56 (2017): 96-104.
[76] Liu, Tong, Gang Shi, Liwei Chen, Fei Zhang, Yaxuan Yang, and Jihu Zhang. “TMDFI: Tagged Memory Assisted for Fine-Grained Data-Flow Integrity Towards Embedded Systems Against Software Exploitation.” In 2018 17th IEEE International Conference On Trust, Security And Privacy In Computing And Communications/12th IEEE International Conference On Big Data Science And Engineering (TrustCom/BigDataSE), pp. 545-550. IEEE, 2018.
[77] Reddy, A L Narasimha, and Prithviraj Banerjee. “A fault secure dictionary machine.” In Data Engineering, 1987 IEEE Third International Conference on, pp. 104-110. IEEE, 1987.
[78] Roessler, Nick, and André DeHon. “Protecting the stack with metadata policies and tagged hardware.” In 2018 IEEE Symposium on Security and Privacy (SP), pp. 478-495. IEEE, 2018.
[79] Shioya, Ryota, Dacwung Kim, Kazuo Horio, Masahiro Goshima, and Shuichi Sakai. “Low-overhead architecture for security tag.” IEICE TRANSACTIONS on Information and Systems 94, no. 1 (2011): 69-78.
[80] Skorstengaard, Lau, Dominique Devriese, and Lars Birkedal. “Enforcing well-bracketed control flow and stack encapsulation using linear capabilities.” In PriSC 2018 Principles of Secure Compilation. 2018.
[81] Sullivan, Gregory T., Andre DeHon, Steven Milburn, Eli Boling, Marco Ciaffi, Jothy Rosenberg, and Andrew Sutherland. “The Dover inherently secure processor.” In Technologies for Homeland Security (HST), 2017 IEEE International Symposium on, pp. 1-5. IEEE, 2017.
[82] Tiwari, Mohit, Banit Agrawal, Shashidhar Mysore, Jonathan Valamehr, and Timothy Sherwood. “A small cache of large ranges: Hardware methods for efficiently searching, storing, and updating big dataflow tags.” In Proceedings of the 41st annual IEEE/ACM International Symposium on Microarchitecture, pp. 94-105. IEEE Computer Society, 2008.
[83] Watson, Robert Nicholas, Peter G. Neumann, and Simon W. Moore. “Balancing Disruption and Deployability in the CHERI Instruction-Set Architecture (ISA).” MIT Press, 2017.
[84] Watson, Robert NM, Jonathan Woodruff, Michael Roc, Simon W. Moore, and Peter G. Neumann. Capability Hardware Enhanced RISC Instructions (CHERI): Notes on the Meltdown and Spectre Attacks. No. UCAM-CL-TR-916. University of Cambridge, Computer Laboratory, 2018.
[85] Wilkerson, Christopher B. “System and method to bypass execution of instructions involving unreliable data during speculative execution.” U.S. Pat. No. 7,114,059, issued Sep. 26, 2006.
[86] Wong, Ming Ming, Jawad Haj-Yahya, and Anupam Chattopadhyay. “SMARTS: secure memory assurance of RISC-V trusted SoC.” In Proceedings of the 7th International Workshop on Hardware and Architectural Support for Security and Privacy, p. 6. ACM, 2018.
[87] Woodruff, Jonathan David, A. Joannou, Robert Kovacsics, Simon William Moore, A. Bradbury, H. Xia, R. N. M. Robert et al. “Efficient Tagged Memory.” (2018).
[88] Xia, Yubin, Yutao Liu, Haibo Chen, and Binyu Zang. “CFIMon: Detecting violation of control flow integrity using performance counters.” In Dependable Systems and Networks (DSN), 2012 42nd Annual IEEE/IFIP International Conference on, pp. 1-12. IEEE, 2012.
[89] Yang, L. I., and Jun-wei LI. “A Technique Preventing Code Reuse Attacks Based on RISC Processor.” DEStech Transactions on Computer Science and Engineering CCNT (2018).
[90] Yao, Zhihao, Saced Mirzamohammadi, Ardalan Amiri Sani, and Mathias Payer. “Milkomeda: Safeguarding the Mobile GPU Interface Using WebGL Security Checks.” In Proceedings of the 2018 ACM SIGSAC Conference on Computer and Communications Security, pp. 1455-1469. ACM, 2018.
[91] Zeldovich, Nickolai, Hari Kannan, Michael Dalton, and Christos Kozyrakis. “Hardware Enforcement of Application Security Policies Using Tagged Memory.” In OSDI, vol. 8, pp. 225-240. 2008.
[92] Zeldovich, Nickolai, Silas Boyd-Wickizer, Eddie Kohler, and David Mazières. “Making information flow explicit in HiStar.” In Proceedings of the 7th symposium on Operating systems design and implementation, pp. 263-278. USENIX Association, 2006.

TABLE 1
Examples of Data Word Tag Values, Their Meaning and Usage.

| Data Word | |
|---|---|
| Tag Value | Meaning/Use |
| [INV] | Invalid, uninitialized |
| [PW] | Writeable by writer with appropriate privilege |
| [PRW] | Readable and writeable by writers with the appropriate privilege. |
| [REA] | Return address, cannot be overwritten. Call instruction sets this tag, cleared |
| | to INV on return |
| [MCM], | Mapped control register, writeable (MCM) or immutable-this is, not |
| [MCI] | writeable (MCI) |
| [JTI] | Jump table entry and immutable (=non-writeable) |
| [SP0], | Secured pointer types used for accessing a fenced region in permitted modes |
| [SP1] | with automatic bounds checking (Technique 4). Between two adjacent |
| | memory words tagged as [SP0] and [SP1], specify the base address and size |
| | of a fenced memory region and the permitted access mode. Both types of |
| | pointers are marked as immutable and usable only by specially-tagged |
| | memory instructions. |
| [DPR], | Protected domain function pointers. These come in two flavors resolved |
| [DPU] | (DPR) and unresolved (DPU). These are used to transfer control to protection |
| | domains (Technique 5). Both types of pointers are marked as immutable and |
| | non-copyable at compile time. |
| Data type | Several types, with other variations (immutable, readable/writeable etc.)- |
| tags | unsigned, integers, floats, doubles etc. Used for type enforcements based on |
| | permitted language semantics. |
| [TAI] | Potentially tainted data. Data coming in from external sources (such as via |
| | the network) or DMA are tagged like this unless certified by a trusted |
| | program to be of specific type. |
| [TBS] | Words in potentially tainted byte string passed as argument, for example, as |
| | network packet payload, Technique 7. |
| Reserved | Reserved for use by system |

TABLE 2
Examples of Instruction Word Tag Values, Their Meaning and Usage.

| Instruction | |
|---|---|
| Word Tag | |
| Value | Meaning/Use |
| [INV] | Invalid, uninitialized |
| [IMI] | Immutable instruction (not modifiable). For safety, unless intended |
| | otherwise by the system, all generated instructions are immutable and data |
| | cannot be executed as instruction. |
| [TRT], | Target of a return from a function call, immutable (TRT) and target of a |
| [TCA] | function call (TCA)-Technique 4. |
| [TIN] | Target of an indirect branch |
| [RFN] | Instruction implementing a return from a function call (which could be an |
| | ordinary JUMP instruction instead of a return instruction). |
| [EPD], | Instruction at legal entry point of a module/protection domain (EPD) and |
| [EXD] | exit point (EXD). Modules or domains can have multiple entry and exit |
| | points. |
| [DIN] | Instruction within a protection domain, immutable by default |
| [LBR] | LOAD instruction capable of loading a bounds register with pointers tagged |
| | as [SP0], [SP1], Technique 4 |
| [FMA] | Memory instructions (LOADs or STOREs) capable of accessing a fenced |
| | memory region with bounds register and automatic bounds checking, |
| | Technique 4. |
| [ENC] | Used for STOREs-result has to be encrypted before the memory update. A |
| | series of these stores deposit data into an internal encryption buffer before |
| | encryption and writing to memory by the memory encryption/decryption |
| | logic. |
| [CDT] | Cross-domain JUMP (unconditional) or system call (using unresolved |
| | pointer, Technique 5) |
| [EMD] | In-lined metadata embedded within code containing information for access |
| | checking at entry point to a protected domain, enabling local exception |
| | handler of specific type, labeling source of indirect jump at target. These are |
| | immutable by default. Note that words tagged as [EMD] are not |
| | instructions, but they appear within code, so their tag is interpreted in the |
| | context of a code page. |
| Reserved | Reserved for use by system |

TABLE 3
Common Weakness Evaluation

| CWE Class | Examples | SP Mechanism Addressing CWE |
|---|---|---|
| Buffer errors | Stack attacks including ROP | Instruction and return address tagging |
| | CWE119: improper restriction of | Bounds registers implementing fenced |
| | operation within memory area | memory area |
| | CWE120: buffer copying without | |
| | checking buffer size | |
| Permissions, | CWE-250: execution with | Access-controlled protection domains, |
| privileges, access | unnecessary privilege | access to data in least-necessary mode |
| control | CWE-306: missing authentication | |
| | of critical functions | |
| Resource | CWE-732: incorrect permission | PD encapsulating resource + memory |
| management | for critical resources | encryption, memory-mapped, tagged |
| | | device control registers in fenced area + |
| | | BR |
| | CWE-22: Improper Limitation of | Word tagging to taint input arguments and |
| | a Pathname to a Restricted | software handlers on using tainted |
| | Directory, | arguments |
| | CWE-494: Download of Code | |
| | Without Integrity Check | |
| Code injection | JOP | Tagging of jumps, jump table entries, |
| | | targets + CFI markers in in-lined MD |
| | Executing data as instructions | Data word tags disabling execution + |
| | | separate data and instruction pages |
| | CWE-89: SQL injection, CWE- | Word tagging to taint input arguments |
| | 79: cross-domain scripting | [TBS] and software handlers on using |
| | | tainted argument words of byte sequence |
| Information | Information exposure through | Access controlled PDs, tag marking data |
| leakage | error message (CWE-209), debug | as sensitive, memory encryption |
| | (CWE-215), caching (CWE-524), | |
| | log files (CWE-532) | |
| Crypto error | CWE-306: missing authentication | Access controlled PDs, encryption-needed |
| | of critical functions | tag [ENC] |
| | CWE-327: use of broken crypto | Force use of hardware crypto engine, |
| | | master key in per-tread key register |
| Numeric errors | Operations on incompatible | Data type enforcement through tagging, |
| | operands | tagging result produced as [TAI] |
| | CWE-682: Incorrect Calculation | Tagging result produced with |
| | | overflow/underflow as tainted [TAI] |
| | CWE-198: Use of Incorrect Byte | Words in byte sequence from external |
| | Ordering | sources marked as tainted [TBS], invokes |
| | | handlers on use. Other situations handled |
| | | by compiler. |

What is claimed is:

1. A secure processor, comprising:
an interface configured to receive an executable program comprising instructions and associated instruction tags;
instruction execution hardware; and
tag processing hardware, configured to:
process information in the associated instruction tags to enforce at least one specific context-dependent behavior for a respective instruction during execution of the respective instruction; and
prevent unauthorized modifications of the instruction tags before, during and after execution.

2. The secure processor of claim 1,
wherein the interface is further configured to receive data and associated data tags, associated with at least one operand of a respective instruction; and
wherein each data tag contains information processed by the tag processing hardware, to selectively prevent operations involving an associated operand.

3. The secure processor of claim 2, wherein the tag processing hardware is further configured to:
process information in the associated data tag to enforce at least one of access, use, and storage of respective data; and
selectively authorize modification of the associated data tag under control of the tag processing hardware and the executable program dependent on the associated instruction tags and the associated data tag,
thereby permitting enforcement of context-specific behavior using associated instruction tags in conjunction with at least one data tag of an operand for the respective instruction.

4. The secure processor of claim 3, wherein the tag processing hardware is configured to write the contents of a processor register and a data tag associated with the processor register into a memory location when permitted by the information in the associated instruction tag associated with a respective instruction performing the write in conjunction with the data tag associated with the processor register and a data tag associated with the memory location that is written to by the respective instruction.

5. The secure processor of claim 3, wherein the tag processing hardware is configured to read the contents of a memory location and a data tag associated with the memory location into a processor register when permitted by the information in the associated instruction tag associated with a respective instruction performing the read in conjunction with a data tag associated with the memory location that is read to by the respective instruction.

6. The secure processor of claim 2, wherein information in the associated instruction tag, along with the data tags associated with operands cited in the instruction together determine whether the instruction is able to complete successfully.

7. The secure processor of claim 2, wherein information in the associated instruction tag along with the data tags associated a memory location targeted for use by the instruction together determine whether the instruction is able to complete successfully.

8. The secure processor of claim 2, wherein the instruction tag associated with an instruction allows the instruction to update (a) the data tag of the at least one operand in a register modified by the respective instruction, or (b) the data tag of a memory location accessed by the respective instruction, to indicate that final access on the operand has been completed.

9. The secure processor of claim 1, wherein a range of data memory addresses that can be accessed by the instruction is limited by information in the associated instruction tag and a data tags associated with the memory location.

10. The secure processor of claim 1, wherein instruction tags are placed in a uniform-sized fields located at regular intervals within the executable code for the executable program.

11. The secure processor of claim 10, wherein a plurality of instruction tags within each field have a one-to-one correspondence to a plurality of instructions in the executable program and are adjacent to the field containing instruction tags.

12. The secure processor of claim 11, wherein a size of each field containing instruction tags and a placement interval of the field of instruction tags within the executable program are predetermined.

13. The secure processor of claim 10, wherein the fields appear at least once within a single cache line within an instruction cache closest to the secure processor.

14. The secure processor of claim 1, wherein instruction tags are placed in variable-sized fields placed within the executable program, with a plurality of instruction tags within each field having a one-to-one correspondence to a plurality of instructions in the executable program that are adjacent to the field, and
wherein each field has information that indicates a size of the tag field and how the instruction tags correspond one-on-one to instructions adjacent to the field.

15. A secure processing method, comprising:
providing an automated processor having tag processing hardware;
receiving an executable program comprising instructions and associated instruction tags;
processing information in associated instruction tags to enforce at least one specific context-dependent behavior for a respective instruction during execution of the respective instruction; and
preventing unauthorized modifications of the instruction tags before, during and after execution.

16. The secure processing method of claim 15, further comprising receiving data and associated data tags, associated with at least one operand of a respective instruction in memory or in a processor register, wherein each data tag contains information processed by the tag processing hardware, to selectively prevent operations involving an associated operand.

17. The secure processing method of claim 16, further comprising:
processing information in the associated data tag to enforce at least one of access, use, and storage of respective data; and
selectively authorizing modification of the associated data tag under control of the executable program by the hardware dependent on the associated instruction tags,
thereby enforcing of context-specific behavior using associated instruction tags in conjunction with at least one data tag of an operand for the respective instruction.

18. The secure processing method of claim 17, further comprising writing the contents of a processor register and a data tag associated with the processor register into a memory location, when permitted by the information in the associated instruction tag associated with a respective instruction performing the write and optionally by information in the data tag associated with the processor register, in conjunction with a data tag associated with the memory location that is written to by the respective instruction.

19. The secure processing method of claim 17, further comprising reading the contents of a memory location and a data tag associated with the memory location into a processor register, when permitted by the information in the associated instruction tag associated with a respective instruction performing the read, in conjunction with a data tag associated with the memory location that is read by the respective instruction.

20. A processing method, comprising:
receiving an executable program comprising instructions and an instruction tag associated with the instruction by processing hardware, the instruction tags comprising information for enforcement of specific context-dependent behaviors for the corresponding instruction, the instruction tags being stored securely, unmodifiable by program execution, and unmodifiable by the processing hardware; and
processing instructions and corresponding instruction tags for respective instructions, to execute the program while enforcing the specific context-dependent behaviors.

21. The method of claim 20, further comprising receiving data tags associated with the operands of an instruction in registers or memory locations, wherein:
each of the data tags contain information that selectively prevents operations using the operand, and
the data tags are stored securely in the registers and memory locations, and only modifiable by the processor hardware during program execution based on at least one of the instruction tags and optionally the data tags of the operand, thereby permitting context-specific processing to be enforced using instruction tags in conjunction with the data tag of one or a plurality of operands for the instruction.

22. The method of claim 21, further comprising writing contents of a processor register and its associated data tag into a memory location when allowed by the information within the associated instruction tag of an instruction performing the write and in conjunction with the data tag associated with the memory location that is written to by the instruction.

23. The method of claim 21, further comprising reading the contents and the data tag associated with a memory location into at least one processor register when the operation is allowed by the instruction tag associated with the instruction performing the read and optionally the data tags of the operand, and in conjunction with the data tag associated with the memory location that is read by the instruction.

21. The method of claim 21, further comprising determining whether to execute the instruction, read from a memory location, or write to the memory location, based on at least information contained in the instruction tag associated with the instruction and information contained in data tags associated with the memory location targeted for use by the instruction.

25. The method of claim 21, further comprising updating a data tag of an operand modified by an instruction selectively dependent on the instruction tag associated with the instruction, to indicate that the final access on the operand as indicated in the program has been completed.

26. The method of claim 20, further comprising placing instruction tags specifying security operations for individual instructions in uniform-sized fields located at regular intervals within the executable program, with a plurality of instruction tags within each field having a one-to-one correspondence to a plurality of instructions in the executable code that are adjacent to the field containing instruction tags, with the size of each field containing instruction tags and the placement intervals of said field of instruction tags within the executable code being known to processor hardware.

27. The method of claim 20, further comprising embedding the fields containing instruction tags at regular intervals within the executable code to appear at least once within a single cache line within an instruction cache closest to a processor that executes the program.

28. The method of claim 20, further comprising placing instruction tags specifying security operations for individual instructions in variable sized fields within the executable program, with a plurality of instruction tags within each field having a one-to-one correspondence to a plurality of instructions in the executable code that are adjacent to the field containing instruction tags, wherein each field containing instruction tags have information that indicates the size of the field and how the instruction tags correspond one-on-one to instructions adjacent to the field of instruction tags.

29. The method of claim 20, further comprising limiting a range of data memory addresses that can be accessed by an instruction based on an instruction tag associated with the instruction and data tags for the data within the range of data memory contains information.
